(19) United States
(12) Patent Application Publication
(10) Pub. No.: US 2015/0218905 A1
(43) Pub. Date: Aug. 6, 2015

(54) Magnesium Metal Ore Waste in Well Cementing

(71) Applicant: Halliburton Energy Services, Inc., Houston, TX (US)

(72) Inventors: Jiten Chatterji, Duncan, OK (US); Darrell Chad Brenneis, Marlow, OK (US); Craig Wayne Roddy, Duncan, OK (US); Gregory Robert Hundt, Spring, TX (US)

(73) Assignee: HALLIBURTON ENERGY SERVICES, INC., Houston, TX (US)

(21) Appl. No.: 14/363,351

(22) PCT Filed: Jan. 31, 2014
(86) PCT No.: PCT/US2014/014037

§ 371 Date: Jun. 6, 2014

(51) Int. Cl. E21B 33/14; C09K 8/46; B01F 15/02

(52) U.S. Cl. CPC E21B 33/14; B01F 15/0283; C09K 8/46; B01F 2215/0047

(57) ABSTRACT

Methods and compositions are provided that utilize magnesium metal ore waste in well cementing. A method of cementing may comprise introducing a cement composition into a subterranean formation, wherein the cement composition comprises water and a cement component comprising magnesium metal ore waste; and allowing the cement composition to set.

### BACKGROUND

Embodiments relate to cementing operations and, more particularly, in certain embodiments, to methods and compositions that utilize magnesium metal ore waste in well cementing.

In cementing operations, such as well construction and remedial cementing, cement compositions are commonly utilized. Cement compositions may be used in primary cementing operations whereby pipe strings, such as casing and liners, are cemented in wellbores. In a typical primary cementing operation, a cement composition may be pumped into an annulus between the exterior surface of the pipe string disposed therein and the walls of the wellbore (or a larger conduit in the wellbore). The cement composition may set in the annular space, thereby forming an annular sheath of hardened, substantially impermeable material (e.g., a cement sheath) that may support and position the pipe string in the wellbore and may bond the exterior surface of the pipe string to the wellbore walls (or the larger conduit). Among other things, the cement sheath surrounding the pipe string should function to prevent the migration of fluids in the annulus, as well as protecting the pipe string from corrosion. Cement compositions also may be used in remedial cementing methods, such as in squeeze cementing for sealing voids in a pipe string, cement sheath, gravel pack, subterranean formation, and the like.

A broad variety of cement compositions have been used heretofore, including cement compositions comprising Portland cement. Portland cement is generally prepared from a mixture of raw materials comprising calcium oxide, silicon oxide, aluminum oxide, ferric oxide, and magnesium oxide. The mixture of the raw materials is heated in a kiln to approximately 2700° F., thereby initiating chemical reactions between the raw materials. In these reactions, crystalline compounds, dicalcium silicates, tricalcium silicates, tricalcium aluminates, and tetracalcium aluminoferrites, are formed. The product of these reactions is known as a clinker. The addition of a gypsum/anhydrate mixture to the clinker and the pulverization of the mixture results in a fine powder that will react to form a slurry upon the addition of water.

There are drawbacks, however, to the conventional preparation and use of Portland cement. The energy requirements to produce Portland cement are quite high, and heat loss during production can further cause actual energy requirements to be even greater. These factors contribute significantly to the relatively high cost of Portland cement. Generally, Portland cement may be a major component of the cost of the cement composition. Recent Portland cement shortages, however, have further contributed to the rising cost of cement compositions that comprise Portland cement.

The demand for magnesium metal has steadily risen as a result of new applications for magnesium metal and its alloys in a variety of different industries. While a number of different processes may be used for the production of magnesium metal, one of most commonly used processes is the Pidgeon process in which magnesium metal may be produced by a siliothermic reduction that involves the reduction of the oxide at high temperatures with silicon to obtain the metal. However, the Pidgeon process may result in the production of large quantities of solid waste, referred to herein as “magnesium metal ore waste.” The magnesium metal ore waste generally has a high concentration of gamma-Ca₂SiO₄ also referred to as Calcio-Olivine. The magnesium metal ore waste has been considered an undesirable waste that can add undesirable costs to the production of magnesium metal as well as environmental concerns associated with its disposal.

### BRIEF DESCRIPTION OF THE DRAWINGS

These drawings illustrate certain aspects of some of the embodiments of the present invention, and should not be used to limit or define the invention.

FIG. 1 is a schematic illustration of an example system for the preparation and delivery of a cement composition comprising magnesium metal ore waste to a wellbore.

FIG. 2 is a schematic illustration of example surface equipment that may be used in the placement of a cement composition comprising magnesium metal ore waste in a wellbore.

FIG. 3 is a schematic illustration of the example placement of a cement composition comprising magnesium metal ore waste into a wellbore annulus.

### DESCRIPTION OF PREFERRED EMBODIMENTS

Embodiments relate to cementing operations and, more particularly, in certain embodiments, to methods and compositions that utilize magnesium metal ore waste in well cementing. Cement compositions comprising magnesium metal ore waste may be used in a variety of subterranean applications including primary and remedial cementing operations. One of the many potential advantages to these methods and compositions is that an effective use for magnesium metal ore waste may be provided thus minimizing the amount of the waste being deposited in landfills. Another potential advantage of these methods and compositions is that the cost of well cementing may be reduced by replacement of the higher cost Portland cement with the magnesium metal ore waste.

Example cement compositions may comprise water and a cement component comprising magnesium metal ore waste. The cement component may further comprise one or more of hydraulic cement, kiln dust, slag, perlite, shale, amorphous silica, or metakaolin. Some of these additional components (e.g., shale, amorphous silica) may not be cementitious alone but may exhibit cementitious properties when combined with other materials, such as Portland cement or hydrated lime. Other of these additional components (e.g., hydraulic cement, kiln dust, slag) may exhibit cementitious properties. The different materials constituting the cement component may be pre-blended prior to combination with water, but there is no requirement of pre-blending as the present techniques are intended to encompass any suitable method for combining the cement component with water, including pre-blending or independently combining all the different constituents with the water.

The term “magnesium metal ore waste,” as that term is used herein, refers to a solid material generated as a by-product in the production of magnesium metal from the Pidgeon process. In an example Pidgeon process, solid material comprised of calcium dolomite, ferrosilicon, and calcium fluoride, may be heated in furnaces to high temperatures from which MgO may be reduced. The residue of the solid material is a waste product that is generated in large quantities from the production of the Magnesium metal. Because the magnesium metal ore waste has generally been considered an undesirable waste product, its inclusion in the cement compositions for well cementing may help to alleviate environmental concerns associated with its disposal.

The chemical analysis of the magnesium metal from various manufacturers varies depending on a number of factors, including the particular solid material feed and process conditions used in the magnesium metal production processes. The magnesium metal ore waste may comprise a number of different oxides (based on oxide analysis), including, without limitation, Na₂O, MgO, Al₂O₃, SiO₂, CaO, Fe₂O₃, and/or SrO. A sample of magnesium ore waste was subjected to oxide analysis by ICP (Inductively Coupled Plasma Mass Spectrometry) and EDXRF (Energy Dispersive X-Ray Fluorescence) which showed the following composition by weight: Na₂O (0.07%), MgO (4.6%), Al₂O₃ (16.26%) SiO₂ (23.14%), CaO (55.2%), Fe₂O₃ (0.15%), and SrO (0.01%). Moreover, the magnesium metal ore waste generally comprises a number of different crystal structures, including, without limitation, Calcio-Olivine (gamma-Ca₂SiO₄), Mayenite (Ca₁₂Al₁₄O₃₃), Periclase (MgO), and/or Akermanite (CaMg(Si₂O₇)). The magnesium metal ore waste generally has a high concentration of the gamma-Ca₂SiO₄ also referred to as Calcio-Olivine. By way of example, the magnesium metal ore waste may comprise Calcio-Olivine in an amount of about 50% or more by weight and, alternatively, about 70% or more by weight of the magnesium metal ore waste. A sample of magnesium metal ore waste was subjected to X-ray diffraction analysis with Rietveld Full Pattern refinement, which showed the following crystalline materials present by weight:

Calcio-Olivine—gamma-Ca₂SiO₄—78%;

Mayenite—Ca₁₂Al₁₄O₃₃—5%;

Periclase—MgO—11%; and

Akermanite—CaMg(Si₂O₇)—6%.

The magnesium metal ore waste may be ground, for example, to a desirable particle size for subterranean operations. For example, the magnesium metal ore waste may be ground to a d50 particle size distribution of from about 1 micron to about 100 microns and, alternatively, from about 10 microns to about 50 microns. By way of example, the magnesium metal ore waste may have a d50 particle size distribution ranging between any of and/or including any of about 1 micron, about 5 microns, about 10 microns, about 20 microns, about 30 microns, about 40 microns, about 50 microns, about 60 microns, about 70 microns, about 80 microns, about 90 microns, or about 100 microns. One of ordinary skill in the art, with the benefit of this disclosure, should be able to select an appropriate particle for the magnesium metal ore waste for a particular application.

The magnesium metal ore waste may be included in the cement compositions in an amount suitable for a particular application. The concentration of the magnesium metal ore waste may also be selected to provide a low cost replacement for higher cost additives, such as Portland cement, that may typically be included in a particular cement composition. Where present, the magnesium metal ore waste may be included in an amount in a range of from about 1% to 100% by weight of the cement component (“bwoc”). By way of example, the magnesium metal ore waste may be present in an amount ranging between any of and/or including any of about 1%, about 5%, about 10%, about 20%, about 30%, about 40%, about 50%, about 60%, about 70%, about 80%, about 90%, or 100% bwoc. In one particular embodiment, the magnesium metal ore waste may be present in an amount in a range of from about 25% to about 75% bwoc and, alternatively, from about 40% to 60% bwoc. As shown in the Examples below, compressive strength may be developed in cement compositions that comprise the magnesium metal ore waste in concentrations as high as 100% bwoc. One of ordinary skill in the art, with the benefit of this disclosure, should recognize the appropriate amount of the magnesium metal ore waste to include for a chosen application.

The cement component may further comprise hydraulic cement. Any of a variety of hydraulic cements may be suitable including those comprising calcium, aluminum, silicon, oxygen, iron, and/or sulfur, which set and harden by reaction with water. Specific examples of hydraulic cements that may be suitable include, but are not limited to, Portland cements, pozzolana cements, gypsum cements, high alumina content cements, silica cements, and any combination thereof. Examples of suitable Portland cements may include those classified as Classes A, B, C, G, or H cements according to American Petroleum Institute, API Specification for Materials and Testing for Well Cements, API Specification 10, Fifth Ed., Jul. 1, 1990. Additional examples of suitable Portland cements may include those classified as ASTM Type I, II, III, IV, or V.

The hydraulic cement may be included in the cement compositions in an amount suitable for a particular application. The concentration of the hydraulic cement may also be selected, for example, to provide a particular compressive strength for the cement composition after setting. Where used, the hydraulic cement may be included in an amount in a range of from about 1% to about 99% bwoc. By way of example, the hydraulic cement may be present in an amount ranging between any of and/or including any of about 1%, about 5%, about 10%, about 20%, about 30%, about 40%, about 50%, about 60%, about 70%, about 80%, about 90%, or about 99% bwoc. In one particular embodiment, the hydraulic cement may be present in an amount in a range of from about 25% to about 75% bwoc and, alternatively, from about 40% to 60% bwoc. One of ordinary skill in the art, with the benefit of this disclosure, should recognize the appropriate amount of the hydraulic cement to include for a chosen application.

The cement component may further comprise kiln dust. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibits cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. Disposal of the cement kiln dust can add undesirable costs to the manufacture of the cement, as well as the environmental concerns associated with its disposal. The chemical analysis of the cement kiln dust from various cement manufactures varies depending on a number of factors, including the particular kiln feed, the efficiencies of the cement production operation, and the associated dust collection systems. Cement kin dust generally may comprise a variety of oxides, such as SiO₂, Al₂O₃, Fe₂O₃, CaO, MgO, SO₃, Na₂O, and K₂O. Problems may also be associated with the disposal of lime kiln dust, which may be generated as a by-product of the calcination of lime. The chemical analysis of lime kiln dust from various lime manufacturers varies depending on a number of factors, including the particular limestone or dolomitic limestone feed, the type of kiln, the mode of operation of the kiln, the efficiencies of the lime production operation, and the associated dust collection systems. Lime kiln dust generally may comprise varying amounts of free lime and free magnesium, lime stone, and/or dolomitic limestone and a variety of oxides, such as SiO₂, Al₂O₃, Fe₂O₃, CaO, MgO, SO₃, Na₂O, and K₂O, and other components, such as chlorides.

The kiln dust may be included in the cement compositions in an amount suitable for a particular application. The concentration of kiln dust may also be selected to provide a low cost replacement for higher cost additives, such as Portland cement, that may typically be included in a particular cement composition. Where present, the kiln dust may be included in an amount in a range of from about 1% to about 99% bwoc. By way of example, the kiln dust may be present in an amount ranging between any of and/or including any of about 1%, about 5%, about 10%, about 20%, about 30%, about 40%, about 50%, about 60%, about 70%, about 80%, about 90%, or about 99% bwoc. In one particular embodiment, the kiln dust may be present in an amount in a range of from about 25% to about 75% bwoc and, alternatively, from about 40% to 60% bwoc. One of ordinary skill in the art, with the benefit of this disclosure, should recognize the appropriate amount of kiln dust to include for a chosen application.

As previously mentioned, the cement component may further comprise one or more of slag, perlite, shale, amorphous silica, or metakaolin. These additives may be included in the cement component to improve one or more properties of the cement composition, including mechanical properties such as compressive strength.

The cement component may further comprise slag. Slag is generally a granulated, blast furnace by-product from the production of cast iron comprising the oxidized impurities found in iron ore. The slag may be included in embodiments of the slag compositions in an amount suitable for a particular application. Where used, the slag may be present in an amount in the range of from about 0.1% to about 40% bwoc. For example, the slag may be present in an amount ranging between any of and/or including any of about 0.1%, about 10%, about 20%, about 30%, or about 40% bwoc. One of ordinary skill in the art, with the benefit of this disclosure, should recognize the appropriate amount of the slag to include for a chosen application.

The cement component may further comprise perlite. Perlite is an ore and generally refers to a naturally occurring volcanic, amorphous siliceous rock comprising mostly silicon dioxide and aluminum oxide. The perlite may be expanded and/or unexpanded as suitable for a particular application. The expanded or unexpanded perlite may also be ground, for example. Where used, the perlite may be present in an amount in the range of from about 0.1% to about 40% bwoc. For example, the perlite may be present in an amount ranging between any of and/or including any of about 0.1%, about 10%, about 20%, about 30%, or about 40% bwoc. One of ordinary skill in the art, with the benefit of this disclosure, should recognize the appropriate amount of the perlite to include for a chosen application.

The cement component may further comprise shale in an amount sufficient to provide the desired compressive strength, density, and/or cost. A variety of shales are suitable, including those comprising silicon, aluminum, calcium, and/or magnesium. Suitable examples of shale include, but are not limited to, PRESSUR-SEAL® FINE LCM material and PRESSUR-SEAL® COARSE LCM material, which are commercially available from TXI Energy Services, Inc., Houston, Tex. Examples of suitable shales comprise vitrified shale and/or calcined shale Where used, the shale may be present in an amount in the range of from about 0.1% to about 40% bwoc. For example, the shale may be present in an amount ranging between any of and/or including any of about 0.1%, about 10%, about 20%, about 30%, or about 40% bwoc. One of ordinary skill in the art, with the benefit of this disclosure, should recognize the appropriate amount of the shale to include for a chosen application.

The cement component may further comprise amorphous silica. Amorphous silica is generally a byproduct of a ferrosilicon production process, wherein the amorphous silica may be formed by oxidation and condensation of gaseous silicon suboxide, SiO, which is formed as an intermediate during the process. An example of a suitable source of amorphous silica is SILICALITE®, available from Halliburton Energy Services, Inc. Where used, the amorphous silica may be present in an amount in the range of from about 0.1% to about 40% bwoc. For example, the amorphous silica may be present in an amount ranging between any of and/or including any of about 0.1%, about 10%, about 20%, about 30%, or about 40% bwoc. One of ordinary skill in the art, with the benefit of this disclosure, should recognize the appropriate amount of the amorphous silica to include for a chosen application.

The cement component may further comprise metakaolin. Generally, metakaolin is a white pozzolan that may be prepared by heating kaolin clay, for example, to temperatures in the range of about 600° C. to about 800° C. Where used, the metakaolin may be present in an amount in the range of from about 0.1% to about 40% bwoc. For example, the metakaolin may be present in an amount ranging between any of and/or including any of about 0.1%, 10%, about 20%, about 30%, or about 40% bwoc. One of ordinary skill in the art, with the benefit of this disclosure, should recognize the appropriate amount of the metakaolin to include for a chosen application.

The water used in the example cement compositions may include, for example, freshwater, saltwater (e.g., water containing one or more salts dissolved therein), brine (e.g., saturated saltwater produced from subterranean formations), seawater, or any combination thereof. Generally, the water may be from any source, provided, for example, that it does not contain an excess of compounds that may undesirably affect other components in the cement compositions. The water may be included in an amount sufficient to form a pumpable slurry. For example, the water may be included in the cement compositions in an amount in a range of from about 40% to about 200% bwoc and, alternatively, in an amount in a range of from about 40% to about 150% bwoc. By way of further example, the water may be present in an amount ranging between any of and/or including any of about 40%, about 50%, about 60%, about 70%, about 80%, about 90%, about 100%, about 110%, about 120%, about 130%, about 140%, about 150%, about 160%, about 170%, about 180%, about 190%, or about 200% bwoc. One of ordinary skill in the art, with the benefit of this disclosure, should recognize the appropriate amount of the water to include for a chosen application.

Optionally, the cement compositions may further include lime. The lime used in the cement compositions may comprise unhydrated lime, hydrated lime, or a combination thereof. The lime may be included in the cement compositions in an amount suitable for a particular application. For example, the lime may be included in an amount in the range of from about 0.1% to about 25% bwoc. By way of further example, the lime may be present in an amount ranging between any of and/or including any of about 0.1%, about 5%, about 10%, about 15%, about 20%, or about 25% bwoc.

Those of ordinary skill in the art will appreciate that the cement compositions generally may have a density suitable for a particular application. By way of example, the cement compositions may have a density of about 8 pounds per gallon (“lbs/gal”) to about 20 lbs/gal. In certain embodiments, the cement compositions may have a density of about 14 lbs/gal to about 17 lbs/gal. The cement compositions may be foamed or unfoamed or may comprise other means to reduce their densities, such as hollow microspheres, low-density elastic beads, or other density-reducing additives known in the art. Those of ordinary skill in the art, with the benefit of this disclosure, will recognize the appropriate density for a particular application.

Optionally, the cement compositions may be foamed with a foaming additive and a gas, for example, to provide a composition with a reduced density. For example, a cement composition may be foamed to have a density of about 12 lbs/gal or less, about 11 lbs/gal or less, or about 10 lbs/gal or less. By way of further example, the cement composition may be foamed to have a density in a range of from about from about 4 lbs/gal to about 12 lbs/gal and, alternatively, about 7 lbs/gal to about 9 lbs/gal. The gas used for foaming the cement compositions may be any suitable gas for foaming the cement composition, including, but not limited to air, nitrogen, and combinations thereof. Generally, the gas may be present in the cement composition in an amount sufficient to form the desired foam. For example, the gas may be present in an amount in the range of from about 5% to about 80% by volume of the foamed cement composition at atmospheric pressure, alternatively, about 5% to about 55% by volume, and, alternatively, about 15% to about 30% by volume.

Optionally, foaming additives may be included in the cement compositions to, for example, facilitate foaming and/or stabilize the resultant foam formed therewith. The foaming additive may include a surfactant or combination of surfactants that reduce the surface tension of the water. By way of example, the foaming agent may comprise an anionic, nonionic, amphoteric (including zwitterionic surfactants), cationic surfactant, or mixtures thereof. Examples of suitable foaming additives include, but are not limited to: betaines; anionic surfactants such as hydrolyzed keratin; amine oxides such as alkyl or alkene dimethyl amine oxides; cocoamidopropyl dimethylamine oxide; methyl ester sulfonates; alkyl or alkene amidobetaines such as cocoamidopropyl betaine; alpha-olefin sulfonates; quaternary surfactants such as trimethyltallowammonium chloride and trimethylcocoammonium chloride; C8 to C22 alkylethoxylate sulfates; and combinations thereof. Specific examples of suitable foaming additives include, but are not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and combinations thereof. An example of a suitable foaming additive is ZONESEALANT™ 2000 agent, available from Halliburton Energy Services, Inc.

Other additives suitable for use in subterranean cementing operations may also be added to the cement compositions as desired for a particular application. Examples of such additives include, but are not limited to, strength-retrogression additives, set accelerators, set retarders, lightweight additives, gas-generating additives, mechanical-property-enhancing additives, lost-circulation materials, fluid-loss-control additives, defoaming additives, thixotropic additives, and any combination thereof. Specific examples of these, and other, additives include crystalline silica, fumed silica, silicates, salts, fibers, hydratable clays, microspheres, diatomaceous earth, natural pozzolan, zeolite, fly ash, rice hull ash, swellable elastomers, resins, any combination thereof, and the like. A person having ordinary skill in the art, with the benefit of this disclosure, will readily be able to determine the type and amount of additive useful for a particular application and desired result.

Optionally, strength-retrogression additives may be included the cement composition to, for example, prevent the retrogression of strength after the cement composition has been allowed to develop compressive strength when the cement composition is exposed to high temperatures. These additives may allow the cement compositions to form as intended, preventing cracks and premature failure of the cementitious composition. Examples of suitable strength-retrogression additives may include, but are not limited to, amorphous silica, coarse grain crystalline silica, fine grain crystalline silica, or a combination thereof.

Optionally, set accelerators may be included in the cement compositions to, for example, increase the rate of setting reactions. Control of setting time may allow for the ability to adjust to wellbore conditions or customize set times for individual jobs. Examples of suitable set accelerators may include, but are not limited to, aluminum sulfate, alums, calcium chloride, calcium sulfate, gypsum-hemihydrate, sodium aluminate, sodium carbonate, sodium chloride, sodium silicate, sodium sulfate, ferric chloride, or a combination thereof.

Optionally, set retarders may be included in the cement compositions to, for example, increase the thickening time of the cement compositions. Examples of suitable set retarders include, but are not limited to, ammonium, alkali metals, alkaline earth metals, borax, metal salts of calcium lignosulfonate, carboxymethyl hydroxyethyl cellulose, sulfoalkylated lignins, hydroxycarboxy acids, copolymers of 2-acrylamido-2-methylpropane sulfonic acid salt and acrylic acid or maleic acid, saturated salt, or a combination thereof. One example of a suitable sulfoalkylated lignin comprises a sulfomethylated lignin.

Optionally, lightweight additives may be included in the cement compositions to, for example, decrease the density of the cement compositions. Examples of suitable lightweight additives include, but are not limited to, bentonite, coal, diatomaceous earth, expanded perlite, fly ash, gilsonite, hollow microspheres, low-density elastic beads, nitrogen, pozzolan-bentonite, sodium silicate, combinations thereof, or other lightweight additives known in the art.

Optionally, gas-generating additives may be included in the cement compositions to release gas at a predetermined time, which may be beneficial to prevent gas migration from the formation through the cement composition before it hardens. The generated gas may combine with or inhibit the permeation of the cement composition by formation gas. Examples of suitable gas-generating additives include, but are not limited to, metal particles (e.g., aluminum powder) that react with an alkaline solution to generate a gas.

Optionally, mechanical-property-enhancing additives may be included in the cement compositions to, for example, ensure adequate compressive strength and long-term structural integrity. These properties can be affected by the strains, stresses, temperature, pressure, and impact effects from a subterranean environment. Examples of mechanical-property-enhancing additives include, but are not limited to, carbon fibers, glass fibers, metal fibers, mineral fibers, silica fibers, polymeric elastomers, latexes, and combinations thereof.

Optionally, lost-circulation materials may be included in the cement compositions to, for example, help prevent the loss of fluid circulation into the subterranean formation. Examples of lost-circulation materials include but are not limited to, cedar bark, shredded cane stalks, mineral fiber, mica flakes, cellophane, calcium carbonate, ground rubber, polymeric materials, pieces of plastic, grounded marble, wood, nut hulls, formica, corncobs, cotton hulls, and combinations thereof.

Optionally, fluid-loss-control additives may be included in the cement compositions to, for example, decrease the volume of fluid that is lost to the subterranean formation. Properties of the cement compositions may be significantly influenced by their water content. The loss of fluid can subject the cement compositions to degradation or complete failure of design properties. Examples of suitable fluid-loss-control additives include, but not limited to, certain polymers, such as hydroxyethyl cellulose, carboxymethylhydroxyethyl cellulose, copolymers of 2-acrylamido-2-methylpropanesulfonic acid and acrylamide or N,N-dimethylacrylamide, and graft copolymers comprising a backbone of lignin or lignite and pendant groups comprising at least one member selected from the group consisting of 2-acrylamido-2-methylpropanesulfonic acid, acrylonitrile, and N,N-dimethylacrylamide.

Optionally, defoaming additives may be included in the cement compositions to, for example, reduce tendency for the cement composition to foam during mixing and pumping of the cement compositions. Examples of suitable defoaming additives include, but are not limited to, polyol silicone compounds. Suitable defoaming additives are available from Halliburton Energy Services, Inc., under the product name D-AIR™ defoamers.

Optionally, thixotropic additives may be included in the cement compositions to, for example, provide a cement composition that can be pumpable as a thin or low viscosity fluid, but when allowed to remain quiescent attains a relatively high viscosity. Among other things, thixotropic additives may be used to help control free water, create rapid gelation as the slurry sets, combat lost circulation, prevent “fallback” in annular column, and minimize gas migration. Examples of suitable thixotropic additives include, but are not limited to, gypsum, water soluble carboxyalkyl, hydroxyalkyl, mixed carboxyalkyl hydroxyalkyl either of cellulose, polyvalent metal salts, zirconium oxychloride with hydroxyethyl cellulose, or a combination thereof.

The components of the cement compositions may be combined in any order desired to form a cement composition that can be placed into a subterranean formation. In addition, the components of the cement compositions may be combined using any mixing device compatible with the composition, including a bulk mixer, for example. In one particular example, a cement composition may be prepared by combining the dry components (which may be the cement component, for example) with water. Liquid additives (if any) may be combined with the water before the water is combined with the dry components. The dry components may be dry blended prior to their combination with the water. For example, a dry blend may be prepared that comprises the magnesium metal ore waste and the cement component. Other suitable techniques may be used for preparation of the cement compositions as will be appreciated by those of ordinary skill in the art in accordance with example embodiments.

After placement in the subterranean formation, the cement compositions may set to have a desirable compressive strength for well cementing. As used herein, the terms “set” or “setting” refer to the reactions that occur resulting in hardening and compressive strength development after the cement component is mixed with the water. The reactions may be delayed by use of appropriate set retarders. Compressive strength is generally the capacity of a material or structure to withstand axially directed pushing forces. The compressive strength may be measured at a specified time after the cement compositions have been positioned and the cement compositions are maintained under specified temperature and pressure conditions. Compressive strength can be measured by either a destructive method or non-destructive method. The destructive method physically tests the strength of cement composition samples at various points in time by crushing the samples in a compression-testing machine. The compressive strength is calculated from the failure load divided by the cross-sectional area resisting the load and is reported in units of pound-force per square inch (psi). Non-destructive methods may employ a UCA™ ultrasonic cement analyzer, available from Fann Instrument Company, Houston, Tex. Compressive strengths may be determined in accordance with API RP 10B-2, Recommended Practice for Testing Well Cements, First Edition, July 2005.

The cement compositions comprising water and a cement component comprising magnesium metal ore waste may be used in a variety of subterranean cementing applications, including primary and remedial cementing. By way of example, a cement composition may be provided that comprises water and a cement component comprising magnesium metal ore waste. As described above, the cement component may further comprise one or more of hydraulic cement, kiln dust, slag, perlite, shale, amorphous silica, or metakaolin. Additional additives may also be included as described above. The cement composition may be introduced into a subterranean formation and allowed to set therein. As used herein, introducing the cement composition into a subterranean formation includes introduction into any portion of the subterranean formation, including, without limitation, into a wellbore drilled into the subterranean formation, into a near wellbore region surrounding the wellbore, or into both.

Where used in primary cementing, for example, the cement composition may be introduced into an annular space between a conduit (e.g., a casing) located in a wellbore and the walls of a wellbore (and/or a larger conduit in the wellbore), wherein the wellbore penetrates the subterranean formation. The cement composition may be allowed to set in the annular space to form an annular sheath of hardened cement. The cement composition may form a barrier that prevents the migration of fluids in the wellbore. The cement composition may also, for example, support the conduit in the wellbore.

Where used in remedial cementing, a cement composition may be used, for example, in squeeze-cementing operations or in the placement of cement plugs. By way of example, the cement composition may be placed in a wellbore to plug an opening (e.g., a void or crack) in the formation, in a gravel pack, in the conduit, in the cement sheath, and/or between the cement sheath and the conduit (e.g., a microannulus).

An example method may include a method of cementing. The method may comprise introducing a cement composition into a subterranean formation, wherein the cement composition comprises water and a cement component comprising magnesium metal ore waste, and allowing the cement composition to set.

An example well cement composition may comprise water and a cement component comprising magnesium metal ore waste.

An example system for well cementing may comprise a well cement composition comprising water and a cement component comprising magnesium metal ore waste. The example system may further comprise mixing equipment for mixing the well cement composition. The example system may further comprise pumping equipment for delivering the well cement composition to a wellbore.

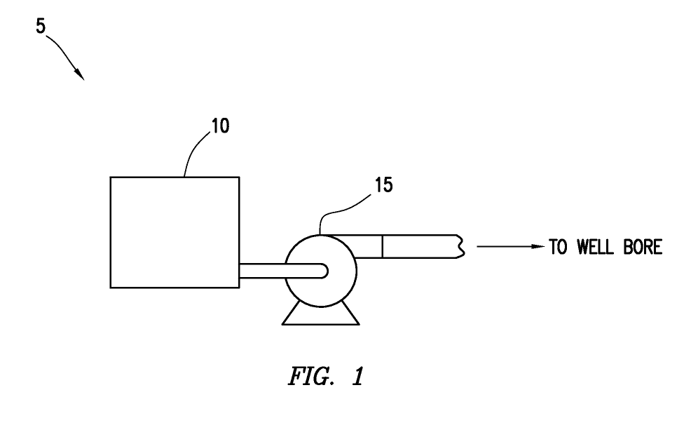

Example methods of using the magnesium metal ore waste in well cementing will now be described in more detail with reference to FIGS. 1-3. FIG. 1 illustrates an example system 5 for preparation of a cement composition comprising water and a cement component comprising magnesium metal ore waste and delivery of the cement composition to a wellbore. As shown, the cement composition may be mixed in mixing equipment 10, such as a jet mixer, re-circulating mixer, or a batch mixer, for example, and then pumped via pumping equipment 15 to the wellbore. In some embodiments, the mixing equipment 10 and the pumping equipment 15 may be disposed on one or more cement trucks as will be apparent to those of ordinary skill in the art. In some embodiments, a jet mixer may be used, for example, to continuously mix a dry blend comprising the cement component, for example, with the water as it is being pumped to the wellbore.

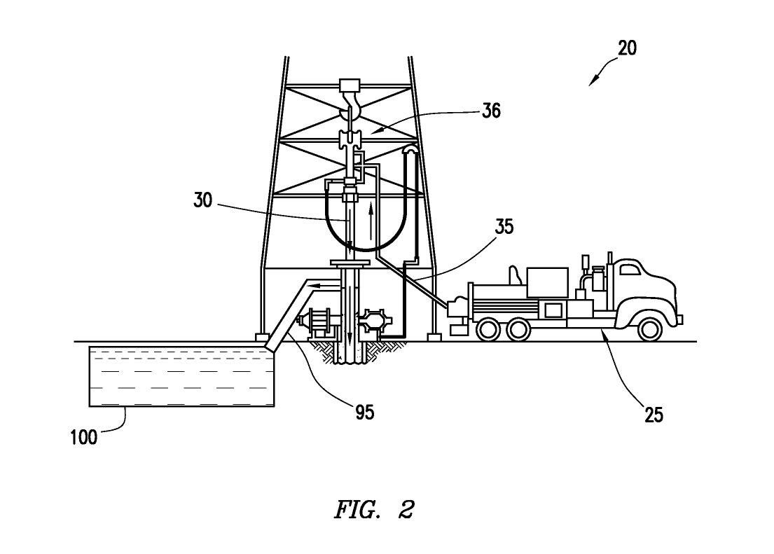

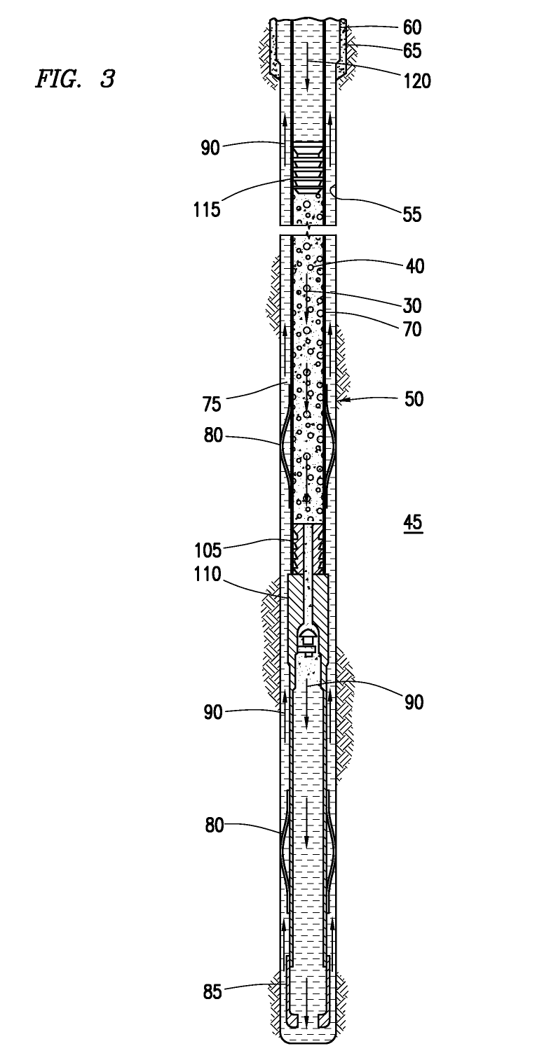

An example technique for placing a cement composition into a subterranean formation will now be described with reference to FIGS. 2 and 3. FIG. 2 illustrates example surface equipment 20 that may be used in placement of a cement composition. It should be noted that while FIG. 2 generally depicts a land-based operation, those skilled in the art will readily recognize that the principles described herein are equally applicable to subsea operations that employ floating or sea-based platforms and rigs, without departing from the scope of the disclosure. As illustrated by FIG. 2, the surface equipment 20 may include a cementing unit 25, which may include one or more cement trucks. The cementing unit 25 may include mixing equipment 10 and pumping equipment 15 (e.g., FIG. 1) as will be apparent to those of ordinary skill in the art. The cementing unit 25 may pump a cement composition 30, which may comprise water and a cement component comprising magnesium metal ore waste, through a feed pipe 35 and to a cementing head 36 which conveys the cement composition 30 downhole.

Turning now to FIG. 3, the cement composition 30, which may comprise the magnesium metal ore waste may be placed into a subterranean formation 45 in accordance with example embodiments. As illustrated, a wellbore 50 may be drilled into one or more subterranean formations 45. While the wellbore 50 is shown extending generally vertically into the one or more subterranean formation 45, the principles described herein are also applicable to wellbores that extend at an angle through the one or more subterranean formations 45, such as horizontal and slanted wellbores. As illustrated, the wellbore 50 comprises walls 55. In the illustrated embodiment, a surface casing 60 has been inserted into the wellbore 50. The surface casing 60 may be cemented to the walls 55 of the wellbore 50 by cement sheath 65. In the illustrated embodiment, one or more additional conduits (e.g., intermediate casing, production casing, liners, etc.), shown here as casing 70 may also be disposed in the wellbore 50. As illustrated, there is a wellbore annulus 75 formed between the casing 70 and the walls 55 of the wellbore 50 and/or the surface casing 60. One or more centralizers 80 may be attached to the casing 70, for example, to centralize the casing 70 in the wellbore 50 prior to and during the cementing operation.

With continued reference to FIG. 3, the cement composition 30 may be pumped down the interior of the casing 70. The cement composition 30 may be allowed to flow down the interior of the casing 70 through the casing shoe 85 at the bottom of the casing 70 and up around the casing 70 into the wellbore annulus 75. The cement composition 30 may be allowed to set in the wellbore annulus 75, for example, to form a cement sheath that supports and positions the casing 70 in the wellbore 50. While not illustrated, other techniques may also be utilized for introduction of the cement composition 30. By way of example, reverse circulation techniques may be used that include introducing the cement composition 30 into the subterranean formation 45 by way of the wellbore annulus 75 instead of through the casing 70.

As it is introduced, the cement composition 30 may displace other fluids 90, such as drilling fluids and/or spacer fluids that may be present in the interior of the casing 70 and/or the wellbore annulus 75. At least a portion of the displaced fluids 90 may exit the wellbore annulus 75 via a flow line 95 and be deposited, for example, in one or more retention pits 100 (e.g., a mud pit), as shown on FIG. 2. Referring again to FIG. 3, a bottom plug 105 may be introduced into the wellbore 50 ahead of the cement composition 30, for example, to separate the cement composition 30 from the other fluids 90 that may be inside the casing 70 prior to cementing. After the bottom plug 105 reaches the landing collar 110, a diaphragm or other suitable device should rupture to allow the cement composition 30 through the bottom plug 105. In FIG. 3, the bottom plug 105 is shown on the landing collar 110. In the illustrated embodiment, a top plug 115 may be introduced into the wellbore 50 behind the cement composition 30. The top plug 115 may separate the cement composition 30 from a displacement fluid 120 and also push the cement composition 30 through the bottom plug 105.

The exemplary magnesium metal ore waste disclosed herein may directly or indirectly affect one or more components or pieces of equipment associated with the preparation, delivery, recapture, recycling, reuse, and/or disposal of the magnesium metal ore waste and associated cement compositions. For example, the magnesium metal ore waste may directly or indirectly affect one or more mixers, related mixing equipment 15, mud pits, storage facilities or units, composition separators, heat exchangers, sensors, gauges, pumps, compressors, and the like used generate, store, monitor, regulate, and/or recondition the exemplary magnesium metal ore waste and fluids containing the same. The disclosed magnesium metal ore waste may also directly or indirectly affect any transport or delivery equipment used to convey the magnesium metal ore waste to a well site or downhole such as, for example, any transport vessels, conduits, pipelines, trucks, tubulars, and/or pipes used to compositionally move the magnesium metal ore waste from one location to another, any pumps, compressors, or motors (e.g., topside or downhole) used to drive the magnesium metal ore waste, or fluids containing the same, into motion, any valves or related joints used to regulate the pressure or flow rate of the magnesium metal ore waste (or fluids containing the same), and any sensors (i.e., pressure and temperature), gauges, and/or combinations thereof, and the like. The disclosed magnesium metal ore waste may also directly or indirectly affect the various downhole equipment and tools that may come into contact with the magnesium metal ore waste such as, but not limited to, wellbore casing 70, wellbore liner, completion string, insert strings, drill string, coiled tubing, slickline, wireline, drill pipe, drill collars, mud motors, downhole motors and/or pumps, cement pumps, surface-mounted motors and/or pumps, centralizers 80, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

To facilitate a better understanding of the present invention, the following examples of some of the preferred embodiments are given. In no way should such examples be read to limit, or to define, the scope of the invention.

### Example 1

The following series of tests were performed to evaluate the mechanical properties of the cement compositions comprising magnesium metal ore waste. Five different cement compositions, designated Samples 1-5, were prepared using the indicated amounts of Portland Class H cement, cement kiln dust, and/or magnesium metal ore waste. Sufficient water was included in the sample cement compositions to provide a density of 14 lbs/gal. The samples were prepared by combining the solid components with water while mixing in a Waring blender. The cement kiln dust used in the tests was supplied by Holcem Cement Company, Ada, Okla. The magnesium metal ore waste used for these test had a d50 particle size distribution of from 10 to 50 microns. The magnesium metal ore waste was subjected to oxide analysis by 1CP (Inductively Coupled Plasma Mass Spectrometry) and EDXRF (Energy Dispersive X-Ray Fluorescence) which showed the following composition by weight: Na₂O (0.07%), MgO (4.6%), Al₂O₃ (16.26%) SiO₂ (23.14%), CaO (55.2%), Fe₂O₃ (0.15%), and SrO (0.01%). Moreover, the magnesium metal ore waste was also subjected to X-ray diffraction analysis with Rietveld Full Pattern refinement, which showed the following crystalline materials present by weight: Calcio-Olivine—gamma-Ca₂SiO₄—78%; Mayenite—Ca₁₂Al₁₄O₃₃—5%; Periclase—MgO—11%; and Akermanite—CaMg(Si₂O₇)—6%.

After preparation, the samples were allowed to cure for twenty-four hours in 2″ by 4″ metal cylinders that were placed in a water bath at 140° F. to form set cylinders. Immediately after removal from the water bath, destructive compressive strengths were determined using a mechanical press in accordance with API RP 10B-2. The results of the tests are set forth below. The data is an average of three tests for each sample.

TABLE 1

| | | | | | | 24-Hr |
|---|---|---|---|---|---|---|
| | Den- | | Class H | Magnesium | Cement | Comp. |
| | sity | | Portland | Metal Ore | Kiln | Strength |
| Sam- | (lbs/ | Water | Cement | Waste | Dust | @ 140° |
| ple | gal) | (% bwoc) | (% bwoc) | (% bwoc) | (% bwoc) | F. (psi) |
| 1 | 14 | 66.61 | 0 | 100 | 0 | 112 |
| 2 | 14 | 67.30 | 25 | 75 | 0 | 180 |
| 3 | 14 | 68.00 | 50 | 50 | 0 | 233 |
| 4 | 14 | 68.69 | 75 | 25 | 0 | 734 |
| 5 | 14 | 61.22 | 0 | 50 | 50 | 270 |

Based on the results of these tests, cement compositions comprising magnesium metal ore waste may develop compressive strength suitable for use in subterranean applications. The blending of the magnesium metal ore waste with one or more additional components, such as Portland cement or cement kiln dust had an impact on compressive strength development.

### Example 2

The following series of tests were performed to evaluate the mechanical properties of foamed cement compositions comprising magnesium metal ore waste. Two different base cement compositions were prepared using the amounts of Portland Class H cement and magnesium metal ore waste indicated in Table 2 below. Sufficient water was included in the base cement compositions to provide a density of 14 lbs/gal. The base cement compositions were prepared by combining the solid components with water while mixing in a Waring blender. The magnesium metal ore waste used for these tests was the same as from Example 1. Next, a foaming additive (2% by volume of water, ZONESEAL® 2000 foaming additive) was included in each base cement composition, and the compositions were foamed down to 12.5 lbs/gal by blending in a Waring blender.

After preparation, the foamed samples were allowed to cure for twenty-four hours in 2″ by 4″ metal cylinders that were placed in a water bath at 140° F. to form set cylinders. Immediately after removal from the water bath, destructive compressive strengths were determined using a mechanical press in accordance with API RP 10B-2. The results of the tests are set forth below. The data is an average of three tests for each sample.

TABLE 2

| | | | Class H | Magnesium | 24-Hr Comp. |
|---|---|---|---|---|---|
| | Foam | | Portland | Metal Ore | Strength @ |
| | Density | Water | Cement | Waste | 140° F. |
| Sample | (lbs/gal) | (% bwoc) | (% bwoc) | (% bwoc) | (psi) |
| 6 | 12.5 | 67.87 | 75 | 25 | 353 |
| 7 | 12.5 | 67.87 | 50 | 50 | 137 |

Based on the results of these tests, foamed cement compositions comprising magnesium metal ore waste may develop compressive strength suitable for use in subterranean applications. The results further show that varying the amount of the Portland cement blended with the magnesium metal ore waste impacts compressive strength development.

### Example 3

The following series of tests were performed to evaluate the mechanical properties of the cement compositions with various blends of additives in the cement component. Nine different cement compositions, designated Samples 8-16, were prepared using the indicated amounts of Portland Class H cement, cement kiln dust, magnesium metal ore waste, slag, perlite, shale, amorphous silica, metakaolin, and/or hydrated lime. The magnesium metal ore waste and cement kiln dust used for these tests was the same as from Example 1. The slag was granulated blast furnace slag supplied by Lafarge North America, under the tradename NewCem® slag cement. The perlite was supplied by Hess Pumice Products, Inc., Malad City, Id., under the tradename IM-325 with a mesh size of 325. The amorphous silica used for the tests was SILICALITE™ cement additive, available from Halliburton Energy Services, Inc. The metakaolin used for the tests was supplied by BASF Corporation under the tradename MetaMax® cement additive. The hydrated lime used for the tests was supplied by Texas Lime Co, Cleburne, Tex.

After preparation, the samples were allowed to cure for twenty-four hours in 2″ by 4″ metal cylinders that were placed in a water bath at 140° F. to form set cylinders. Immediately after removal from the water bath, destructive compressive strengths were detei mined using a mechanical press in accordance with API RP 10B-2. The results of this test are set forth below. The data is an average of three tests for each sample.

TABLE 3

| | | | | | | | | | | | | 24-Hr |
|---|---|---|---|---|---|---|---|---|---|---|---|---|
| | Den- | | Class H | Magnesium | Cement | | | | | | | Comp. |
| | sity | Water | Portland | Metal Ore | Kiln | | | | Amorphous | | Hydrated | Strength |
| Sam- | (lbs/ | (% | Cement | Waste | Dust | Slag | Perlite | Shale | Silica | Metakaolin | Lime | @ 140° F. |
| ple | gal) | bwoc) | (% bwoc) | (% bwoc) | (% bwoc) | (% bwoc) | (% bwoc) | (% bwoc) | (% bwoc) | (% bwoc) | (% bwoc) | (psi) |
| 8 | 14 | 67.82 | 50 | 25 | 0 | 25 | 0 | 0 | 0 | 0 | 0 | 666 |
| 9 | 14 | 60.06 | 50 | 25 | 0 | 0 | 25 | 0 | 0 | 0 | 0 | 496 |
| 10 | 14 | 63.52 | 50 | 25 | 0 | 0 | 0 | 25 | 0 | 0 | 0 | 388 |
| 11 | 14 | 63.62 | 50 | 25 | 0 | 0 | 0 | 0 | 25 | 0 | 0 | 2120 |
| 12 | 14 | 56.61 | 0 | 25 | 50 | 0 | 0 | 0 | 25 | 0 | 0 | 780 |
| 13 | 14 | 69.57 | 50 | 25 | 0 | 0 | 0 | 0 | 0 | 25 | 10 | 1599 |
| 14 | 14 | 70.98 | 50 | 25 | 0 | 25 | 0 | 0 | 0 | 0 | 10 | 972 |
| 15 | 14 | 62.57 | 0 | 25 | 50 | 0 | 0 | 0 | 0 | 25 | 10 | 1107 |
| 16 | 14 | 63.97 | 0 | 25 | 50 | 25 | 0 | 0 | 0 | 0 | 10 | 1141 |

Sample 13 was further subjected to thickening time and fluid-loss tests in accordance with API RP 10B-2 at 140° F. Thickening time is generally a measure of the time the sample cement composition remains in a fluid state capable of being pumped. For this test, the thickening time was the time the sample reached 70 Bearden units of consistency (“Be”). The fluid-loss test is generally a measure of the effectiveness of a cement composition to retain its water phase. Too much fluid loss can be problematic and result in dehydration and bridging off, which may ultimately preventing proper placement of the cement composition, among other problems. For these tests a cement dispersant (0.25% bwoc, CFR-3™ Dispersant), a fluid loss control additive (0.5%, bwoc, Halad®-344 fluid loss additive), and a set retarder (1% bwoc, HR®-25 cement retarder), each available from Halliburton Energy Services, Inc., were further included in the sample. The results of the additional tests are set forth below. The data is an average of three tests for the sample.

TABLE 4

| | | | Class H | Magnesium | | | | Fluid |
|---|---|---|---|---|---|---|---|---|
| | | | Portland | Metal Ore | | Hydrated | Thickening | Loss |
| | Density | Water | Cement | Waste | Metakaolin | Lime | Time to 70 | (cc/30 |
| Sample | (lbs/gal) | (% bwoc) | (% bwoc) | (% bwoc) | (% bwoc) | (% bwoc) | Bc (hr:min) | min) |
| 13 | 14 | 69.57 | 50 | 25 | 25 | 10 | 8:21 | 292 |

Based on the results of these tests, inclusion of various additives in the cement component with the magnesium metal ore waste ash may result in acceptable compressive strengths for a number of subterranean applications. Moreover, Sample 13 was shown to have acceptable thickening time and fluid loss for a number of applications.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of well cementing comprising:
introducing a cement composition into a subterranean formation, wherein the cement composition comprises water and a cement component comprising magnesium metal ore waste; and
allowing the cement composition to set in the subterranean formation.

2. The method of claim 1, wherein the cement composition is introduced into a well-bore annulus between a pipe string disposed in the subterranean formation and a wellbore wall or a larger conduit disposed in the subterranean formation.

3. The method of claim 1, wherein the cement composition is used in a primary cementing operation.

4. The method of claim 1, wherein the cement composition is used in a remedial cementing operation.

5. The method of claim 1, wherein the cement composition is introduced through a casing and into a wellbore annulus using one or more pumps.

6. The method of claim 1, wherein the magnesium metal ore waste comprises solid waste from a Pidgeon process for production of magnesium metal, the magnesium metal ore waste comprising Calcio-Olivine in an amount of about 70% or more by weight of the magnesium metal ore waste.

7. The method of claim 1, wherein the cement component further comprises a cementitious material selected from the group consisting of hydraulic cement, kiln dust, and any combination thereof.

8. The method of claim 1, wherein:
the cement component further comprises Portland cement in an amount of about 25% to about 75% by weight of the cement component; and
the magnesium metal ore waste is present in an amount of about 25% to about 75% by weight of the cement component.

9. The method of claim 1, wherein the cement component further comprises cement kiln dust.

10. The method of claim 9, wherein the cement kiln dust is present in an amount of about 25% to about 75% by weight of the cement component, and wherein the magnesium metal ore waste is present in an amount of about 25% to about 75% by weight of the cement component.

11. The method of claim 1, wherein the cement component further comprises an additional component selected from the group consisting of slag, perlite, shale, amorphous silica, metakaolin, and any combination thereof.

12. The method of claim 1, wherein:
the cement composition further comprises lime in an amount of about 1% to about 20% by weight of the cement component;
the cement component further comprises metakaolin in an amount of about 10% to about 40% by weight of the cement component;
the cement component further comprises Portland cement in an amount of about 40% to about 60% by weight of the cement component; and
the magnesium metal ore waste is present in an amount of about 10% to about 40% by weight of the cement component.

13. The method of claim 1, wherein the cement composition is foamed and further comprises a foaming additive and a gas.

14. The method of claim 1, wherein the cement composition further comprises at least one additive selected from the group consisting of a strength-retrogression additive, a set accelerator, a set retarder, a lightweight additive, a gas-generating additive, a mechanical-property-enhancing additives, a lost-circulation material, a fluid loss control additive, a foaming additive, a defoaming additive, a thixotropic additive, and any combination thereof.

15.-24. (canceled)

25. A system for well cementing comprising:
a well cement composition comprising water and a cement component comprising magnesium metal ore waste;
mixing equipment for mixing the well cement composition; and
pumping equipment for delivering the well cement composition to a wellbore.

26. (canceled)
